(19) United States
(12) Patent Application Publication
(10) Pub. No.: US 2008/0249750 A1
(43) Pub. Date: Oct. 9, 2008

(54) Acoustic structure of porous material

(76) Inventor: Chi-Min Mao, Irvine, CA (US)

Correspondence Address: CHI-MIN MAO, 655 BELLE TERRE. RD., APT. 11, PORT JEFFERSON, NY, 11777, US

(21) Appl. No.: 11/626,376

(22) Filed: Apr. 5, 2007

(51) Int. Cl. G06F 7/60

(52) U.S. Cl. 703/2

(57) ABSTRACT

Empirical equations for porous material to describe the frequency property of the microstructure and predict their sound absorption performance. These empirical equations systematically establish a solid system that relates the porosity, the flow resistance and the air mass to their frequency property and describe how to predict sound absorption coefficient in different thickness. These empirical equations reveal that the microstructure are not uniform across the thickness when the materials are exposed to the sound field. The flow resistance is one of the microstructure and is found to be a step function of the frequency. An interchangeability between the thickness and the frequency was established to predict sound absorption coefficient.

### BACKGROUND OF THE INVENTION

1. Field of the Invention

This invention relates generally to three empirical equations in frequency domain. More particularly, this invention relates to three empirical equations that compute the porosity of the materials, the added specific air mass in pore and the flow resistance of the flexible porous materials, and which generally predict material properties in different thickness.

2. Description of the Related Art

New Evolution—Same Old Problems—Flexible Porous Material Remains a Matter of Concern in Noise Control

Over the last fifty years, experimental sound and noise control has evolved two concepts: the active noise control using controllable materials (smart materials) such as piezoelectric ceramics (PZT) to cancel unwanted sound or noise and the passive noise control using porous materials or non-porous materials with membrane-like structure to absorb noise, that always induces structure vibration thus result in serious damages to the structure itself. Initial efforts focused solely on the frequency-independent properties and relied on the capability of the instrument that predominantly measures single property of the porous material. These early measurement methods actually measure single sound absorption properties of the material, and did not rely on data and model analysis techniques to complete crucial measurement on frequency-dependent properties of the porous material owing to the limit of the test equipment.

A key step in most of noise absorption application,in the area of noise and vibration control using porous material as a means is to sufficiently understand the frequency-dependent properties; of the porous materials. These properties are Specific Mass Ratio (M), Porosity (P) and Flow Resistance (R). For years, many researchers and scientists were devoted themselves to explain these properties because they directly or indirectly effect fabrication methods, prototyping, model prediction, living quality and cost reduction, . . . etc. Over the same course of time, the growth of the new materials was fast but the information about these fundamental properties are still limited This results in the increased importance on the research of the material modeling, the acoustic modeling and the time-intensive numerical computation.

### Subjectivity and Inherence of the Test Equipment Prohibit Wide Scale Developments—Todays Hypothesis are Actually not Quite Adequate

For the lack of good understanding of fundamental properties, M, P and R, the error of the prediction of sound absorption coefficient is not negligible and often misleads to select correct material from a wide range of the materials at early design stage. Up to now, the current technology are still not able to correctly provide, for example, us the detail mechanism of how air flow resistance, a measurement of air permeability of the material, was effected by the frequency in audio range, and how it was coupled by other properties such as the porosity and the added air mass. Still, those are very interesting topic in noise and vibration control area.

Even if the introduction of the sophisticated equipment, the inaccuracy on modeling the porosity is still high due its size of the micro-structure and its irregularity. The size of the pore is in the range of 10⁻⁵ to 10⁻⁶ meter and its distribution was not uniform and its geometry may not stay constant when material was exposed to the sound field. Moreover, it was coupled by the added ail mass in the pore. The added air mass is a small amount of air in the pore, that is an important, media to convert acoustic energy into heat. Its interaction with the walls of the pore causes the total mass in the pore is no longer a constant. Its total mass is considered as a sum of its static mass plus the inertia mass caused by the viscousity that creates friction force between wall structure and the air, therefore, consume acoustic energy. In addition, the use of a standard acoustic impedance tube and flow resistance apparatus, however, does not ensure that the materials are being properly obtained. In fact, the impedance tube allows us to measure the impedance while current flow resistance apparatus provide us a constant value of the flow resistance at specific thickness. When conditions such as non-uniform thickness of the material, temperature variation or material compression due to external forces, the actual sound absorption coefficient when it was explored to sound field can significantly be changed due to its fundamental material structure was permanently changed. All of these conditions also produce secondary symptoms such as the increasing or decreasing the air flow resistance, internal decreasing of porosity and even decreasing the absorption performances caused by the deformation.

When problems were detected, the result of these variations is not possible to be discovered. Indeed, so many difficulties limit our capability to solve the problem. In fact, impedance tube apparatus provides us only the acoustic impedance. The crucial frequency-dependent properties behind the impedance data are encapsulated. These encapsulated material properties are completely control the absorption performance. These encapsulated frequency-dependent properties are now separated and individually measured without considering frequency effects or the interaction among other properties. The most common used apparatus for flow resistance is limit to steady flow measurement. The porosity was estimated under microscope observation. Unfortunately, none of these test apparatus can obtain correct materials information. Physically realizable acoustic material must rely on clear understandings on fundamental material properties, acoustic energy dissipation mechanism among these properties and mathematical models describing the frequency behaviors.

### Incomplete Empirical Predictions and Limited Efforts to Sound Absorption Coefficient are Being Undertaken—1940 to 2005

With Morse's initial study on acoustic impedance (1940), the study of flexible porous material in the applications of sound absorption goes back more than 60 years. Morse introduced three important material properties, Mass Ratio (M), Flow Resistance (R) and Porosity (P), and introduced a mechanism consisting of these properties to describe sound absorption in porous materials. His effort was fairly successful and a fundamental sound absorption theory was established. His approach is to comprise M, P and R of the porous material in acoustic impedance that was use to compute sound absorption coefficient. The examples shown in his paper used constant values for M, P and R although he had pointed out that they should be functions of frequency. In 1942. Richard Brown built an apparatus for direct measurement of flow resistance of acoustic materials. His approach is to establish a pressure difference and maintained a static air flow across a sample. The pressure difference and the air flow were then used to compute flow resistance. His approach was successful and widely used today.

In 1990, Uno Ingard and John Koch suggested an apparatus to explore the effect of an anisotropy in the flow resistance of a porous material. In their approach, they measured lateral and transverse flow resistance of an anisotropic porous material and a tube was used, in which piston slides and pumps steady air through a porous material to measure the steady air flow and the pressure difference. Their presumption, a cross over frequency was existing in an anisotropic porous material, below which the transverse absorption coefficient is less than the lateral one at the expense of the absorption at high frequency, will be explicable if the flow resistance and its related frequency properties of the porous material is reachable.

In reality, the micro-structure of porous material is considerably more complex. For example an “open cell” polyester urethane foam, the cell structure is pentagonal dodecahedra (12-sided). Cell walls partially open/closed to different degree giving normal variation in air flow resistance from 330 to 1590 MKS rayls. For felt type of foam, cell walls are almost completely removed maintaining the cell skeleton in place. It has layered structure, strongly direction dependent properties. Although current scanning electron microscope can take very detailed pictures of porous structure, their structure are by no means sufficiently regular to be used for quantitative studies For this purpose, metallic material have received many attentions, which has more controllable and regular but less multiplex cell geometry than the mentioned flexible porous material. In 2000, Tian J. Lu, Feng Chen and Deping published their research achievements in Journal of Acoust. Soc. who used cellular metals foam with semiopen cells to explore the sound absorption mechanism in porous material. They pointed out a relationship between the size of the pores and the sound absorption. However, the use of the metallic material restricts the selection of high performance material, reduces the chemical resistance, increases overall weight and operation cost. Dynamic property of the metallic cell, as discussed in frequency domain, is an another unsolved issue when whole structure was excited by external acoustic sources.

There thus remains a long felt need in the art for an effective micro-structure model that can efficiently and adequately ensure that the porosity, the added specific air mass and the air flow resistance of the porous material are predictable with the frequency and the thickness of the material. Such needs have not heretofore been fulfilled in the art.

### SUMMARY OF THE INVENTION

The aforementioned long felt needs are met, and problem solved, by having the exact material properties provided in accordance with the present invention. In a preferred embodiment, the empirical functions comprise an acoustic dispersion relationship for estimation and prediction on elastic porous materials properties in a wide frequency range. The empirical functions further consists of three equations to solve for three important material properties: the porosity, specific air mass in pore and flow resistance. Still more preferably, these empirical functions predict acoustic absorption on almost every elastic porous material without loss their accuracy. Still more preferably, using real, one-time measured material data at a specific thickness, materials properties at other thickness are predictable in a wide frequency range.

In a further preferred aspect of the invention, each robust empirical function is mathematically and physically understood and is a summation of many individual orthogonal functions with adjustable coefficients. These coefficients being adapted to fit any porous material without changing each individual function. Yet more preferably, each individual orthogonal function, accompanying with its coefficient, use the thickness of the material and the frequency to form a unique dispersion variable to precisely compute material properties. Still more preferably, these functions are empirically created but are built by several meaningful physical variables that ensure the prediction functions robustly. In still a further preferred embodiment, these empirical functions comprise the coefficients as many as the number of the orthogonal functions in summation, which systematically and uniquely convert thousands of material data points into few numbers (the coefficients), so as to identify the material (any thickness), simplify the material similarity analysis, save database storage and improve data management. Yet even more preferable, these empirical functions provide means to largely eliminate repeating material testing yet maintain the accuracy on the predicted properties of the material.

Porous materials provided in accordance with the present invention satisfy long felt needs in the art for predicting sound absorption coefficient. These new empirical functions also serve as a important means for predicting random incident sound absorption coefficient which require material properties at different thickness. Furthermore, with the use of a model of the reverberation chamber, a complete system for random sound absorption coefficient can be established. Since the prediction functions of the present invention do not require any complicated computation or hardware, they are very economical to implement at any computer system, and simple to be built in conjunction with current material measurement system. Such results have not heretofore been achieved in the art.

The invention will be best understood by those skilled in the art by reading the following detailed description of the presently preferred embodiment, in conjunction with the results shown on figures and tables.

### DETAILED DESCRIPTION OF THE PRESENTLY PREFERRED EMBODIMENTS

### Impedance Tube and Material Structure Modeling

Let us consider one dimensional acoustic wave equation:

$$\frac{{\partial }^{2} p ( x , t )}{\partial {t}^{2}} = {c}^{2} \frac{{\partial }^{2} p ( x , t )}{\partial {x}^{2}} \qquad ( 1 )$$

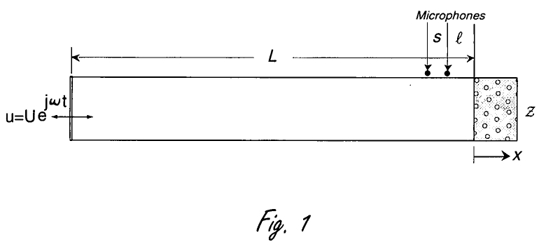

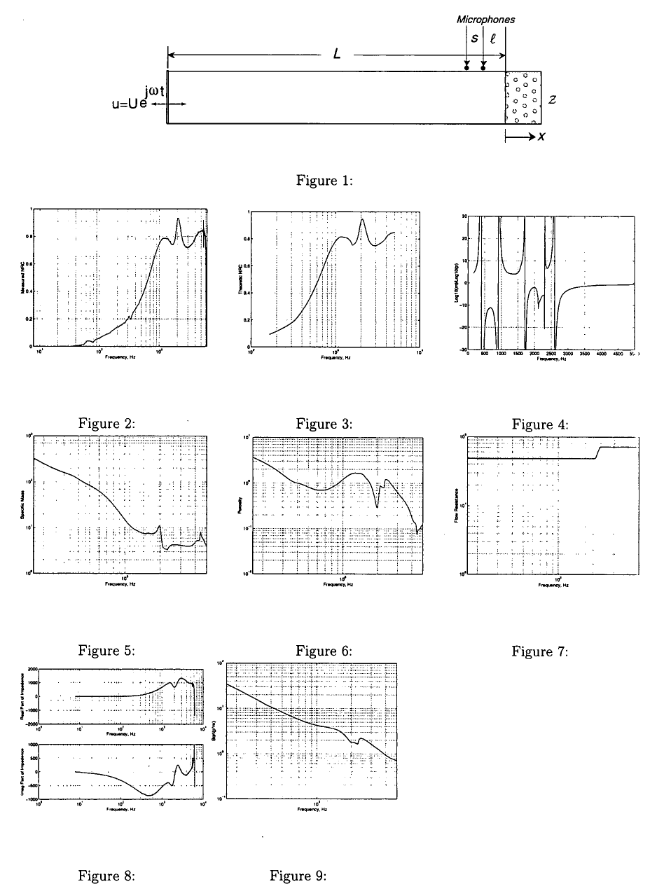

and the boundary conditions

$$\begin{matrix}\frac{\partial p ( x , t )}{\partial x} {\vert}_{x = - L} = - ρ \frac{\partial u ( t )}{\partial t} & ( 2 ) \\ \frac{p ( x , t )}{u ( t )} {\vert}_{x = 0} = {Z}_{b} & ( 3 )\end{matrix}$$

where c is the speed of sound. ρ is the density of air. u(t) is the external velocity excitation source. Z_{b} is the surface acoustic impedance of the porous material as shown in FIG. 1. p(x, t) is the sound pressure distribution in the tube. The solution of p(x, t) in Eq. 1 can be expressed as

$$p ( x , t ) = {c}_{1} {e}^{\\ i ( ω t + kx )} + {c}_{2} {e}^{i ( ω t - kx )} where k = \frac{ω}{c} \qquad ( 4 )$$

is the wave number of the sound. By using the boundary conditions 2 and 3 and defining

$$r = \frac{{c}_{1}}{{c}_{2}} ,$$

we can obtain the surface acoustic impedance

$${Z}_{b} = - ρ c \frac{r + 1}{r - 1} \qquad ( 5 )$$

To solve for two unknowns, Z_{b} and r in Eq. 5, we need one more equation that can be derived by two sound pressure p₁=p(−l) and p₂=p(−l−s), see FIG. 1, in the form of transfer function.

$${G}_{12} = \frac{{p}_{1}}{{p}_{2}} ,$$

to solve for p. After manipulation using Eq. 4, we can solve for r as

$$r = \frac{{G}_{12} - {e}^{- iks}}{{e}^{i ks} - {G}_{12}} {e}^{i 2 k ( 𝓁 + s )} \qquad ( 6 )$$

In practice, considering the discrepancy of the two microphone transducers, correction of the sound pressure p₁ and p₂ is required according to Chung's suggestion [2].

### Material Structure Model

We start with Morse's [3] impedance equation:

$$\begin{matrix}2 \frac{{Z}_{b}}{ρ c} \sqrt{\frac{P}{m}} cos ( {φ}_{r} ) = ( a + b i ) tanh \{ π [ - iσ ( a + b i ) + \frac{1}{2} i ] \} \\ where & ( 7 ) \\ a = \sqrt{2} \sqrt{[ 1 + {( \frac{γ}{σ} )}^{2} ] + 2} & ( 8 ) \\ b = \sqrt{2} \sqrt{[ 1 + {( \frac{γ}{σ} )}^{2} ] - 2} & ( 9 ) \\ σ = \frac{hf}{c} \sqrt{m \times P} cos ( {φ}_{r} ) & ( 10 ) \\ γ = \frac{rh}{2 πρ c} \sqrt{\frac{P}{m}} cos ( {φ}_{r} ) & ( 11 )\end{matrix}$$

and h is the thickness of the test sample, ρ is the density of the air, c is the speed of sound. P is the porosity and is defined as the ratio of the volume of free air in the material to the total volume of the material. m is the specific mass and is defined as ratio of mass of the air inside the material to the mass of open air with same volume of the air inside the material. Due to the viscosity of the air that causes the drag force between the air and the porous structure of the material, m is usually larger than one and we can adequately call it added specific mass that is the sum of the static mass and the inertia mass when porous structure of the material is exposed to a sound field r is the effective resistivity or the flow resistance of the material and is defined as the ratio of the pressure drop per unit thickness to the volume flow of the air through the material. It has an unit of (ρc/h). In order to explore the frequency property of these parameters, the material constants. P, m and r, in Eq. 7 are considered as functions of both the frequency and the thickness of the material, which are now written as P(w, h), m(w, h) and r(w, h).

### Least Square Solutions

In this section we will look into the parameter modeling of the Eq. 7 with respect to the measured impedance data set of the material that has the thickness of hₑ. Despite of the changes of these parameters being considered as variables of frequency, numerically, each frequency point of these parameters, m(w, hₑ), P(w, hₑ) and r(w, hₑ), can be estimated by the least square solutions by iteratively minimizing an error function with each frequency point from data set. The error function is defined as follows:

E=e₁²+e₂² (12)

where

e₁=( [symbol] − [symbol] ₑ) e₂=( [symbol] − [symbol] ₑ) (13)

[symbol]

and [symbol] in Eq. 13 denote the real part and the imaginary part of the impedance, Z_{b}, in Eq. 7. [symbol] and [symbol] ₑ denote the real part and the imaginary part of the data set of the measured impedance. After carefully manipulating Eq. 7, we obtained

$$\begin{matrix}ℜ = \frac{ρ c}{2} \sqrt{\frac{m ( w , h )}{P ( w , h )}} \frac{1}{cos ( {φ}_{r} )} \frac{a sinh 2 x - b sin 2 y}{cosh 2 x + cos 2 y} & ( 14 ) \\ = \frac{ρ c}{2} \sqrt{\frac{m ( w , h )}{P ( w , h )}} \frac{1}{cos ( {φ}_{r} )} \frac{b sinh 2 x + a sin 2 y}{cosh 2 x + cos 2 y} \\ where & ( 15 ) \\ x ( m , P , r , h ) = σ b π \\ y ( m , P , r , h ) = ( - σ a + \frac{1}{2} ) π \\ x , y ∈ R & ( 16 )\end{matrix}$$

During the numerical process, we employ Levenberg-Marquardt method [5] for Eq. 12 and define one gradient matrix,

$$( \begin{matrix}\frac{\partial {e}_{1}}{\partial m} & \frac{\partial {e}_{1}}{\partial P} & \frac{\partial {e}_{1}}{\partial r} \\ \frac{\partial {e}_{2}}{\partial m} & \frac{\partial {e}_{2}}{\partial P} & \frac{\partial {e}_{2}}{\partial r}\end{matrix} )$$

to search for m(w, hₑ), P(w, hₑ) and r(w, hₑ).

### Numerical Difficulty

There is a numerical difficulty on Non-Positive Definite Function shown in Eq. 12 due to more than one local minimum may exist. Therefore, the solutions for m, P and r may not unique!

### Empirical Functions of the Specific Mass and the Porosity

Carefully examining the numerical results computed by Eq. 15 with respect to the data set, Z_{b}, obtained by Eqs. 4 and 6, we discovered a Space-Mass equation and an identity between the porosity and the added air mass. These empirical equations show good agreement in sound absorption coefficients between the theoretic results and the test results among several materials with different thickness. The Space-Mass equation can be expressed as

$$\begin{matrix}p ( w , h ) = {m}^{H} ( w , h ) \\ or & ( 17 ) \\ \frac{log [ p ( w , h ) ]}{log [ m ( w , h ) ]} = H , & ( 18 )\end{matrix}$$

Notice that the added specific mass, when porous structure was exposed in sound field, is greater than one so the condition of log [m(w, h)]≠0 is implied. The identity can be expressed as

$$\begin{matrix}{p}^{log [ m ( w , h ) ]} ( w , h ) = {m}^{log [ p ( w , h ) ]} ( w , h ) \\ or & ( 19 ) \\ log [ p ( w , h ) ] \times log [ m ( w , h ) ] = J \\ where & ( 20 ) \\ H = {\sum }_{n = 0}^{N} \{ {k}_{n 1} Ai [ h ( \frac{w}{c} - \frac{n π}{h} ) ] + {k}_{n 2} Bi [ h ( \frac{w}{c} - \frac{n π}{h} ) ] \} & ( 21 ) \\ J = {\sum }_{n = 0}^{N} \{ {k}_{n 3} Ai [ h ( \frac{w}{c} - \frac{n π}{h} ) ] + {k}_{n 4} Bi [ h ( \frac{w}{c} - \frac{n π}{h} ) ] \} & ( 22 )\end{matrix}$$

Ai[] and Bi[] are the modified Airy functions [4] of the first and the second kind respectively kₙ₁, kₙ₂, kₙ₃ and kₙ₄ are the specific material constants for the porosity and the added specific mass.

$$\frac{n π}{h}$$

is the material wave number in the material space 0≦x≦h, see FIG. 1, where the material is placed. Our empirical equations also show that the absorption performance of the materials has strong connection to the dispersion relationship

$$h ( \frac{ω}{c} - \frac{n π}{h} )$$

in Eqs. 21 and 22. It shows that a high absorption coefficient appears when the value of the dispersion relationship becomes positive. In other words, the thinner material, h<hₑ, usually has higher absorption, coefficient at higher frequency (larger w value). Likewise, thicker material, h>hₑ, has higher absorption coefficient at relatively lower frequency.

### Emperical Function of the Flow Resistance

The clearest difference among the flow resistance, the porosity and the specific added mass was a step function of the flow resistance in frequency domain. In contract to the porosity and the specific added mass, the modeling of a non-continuous function of the flow resistance that has leaping states in frequency domain is hard to be accomplished. Indeed, it suggested that we consider the total flow resistance as a function coupled by the porosity and the added specific mass, which is

$$\begin{matrix}h \times r ( w , h ) \times \sqrt{\frac{p ( w , h )}{m ( w , h )}} = K \\ where & ( 23 ) \\ K = {\sum }_{n = 0}^{N} \{ {k}_{n 5} Ai [ h ( \frac{w}{c} - \frac{n π}{h} ) ] + {k}_{n 6} Bi [ h ( \frac{w}{c} - \frac{n π}{h} ) ] \} & ( 24 )\end{matrix}$$

and Ai[], Bi[] and nπ/h are the same definition as Eq. 17 and 19. kₙ₅ and kₙ₆ are the specific material constants for flow resistance.

### Acoustic Property Prediction

In previous section, acoustic properties of the material, such as impedance, porosity and flow resistance, have been described as functions of both the frequency and the thickness of the material. The modeling seems to be successful in that it captures some of the basic acoustic characteristics of the porous materials. Starting with a data set, m(w, hₑ), P(w, hₑ) and r(w, hₑ), the modeling system, H, J and K will fall into a best-fitted material constants, kₙ₁ to kₙ₆. The effects of the thickness, h, that cause changes in the behavior of Airy Function and determine a good sound absorption frequency point of the material have been investigated experimentally and these effects are apparently reflected the observed results. Thus the models can be used to both represent the known behavior of these material properties and to predict the behavior to different thickness from the computation results of Eqs. 17, 19 and 23 with a value of hₑ.

Examining the augment of Eqs. 21, 22 and 24, we found the thickness h and the frequency w are interchangeable. To achieve the prediction, interchangeability between h and w is employed and we list few interesting cases for

$$h = \frac{{h}_{e}}{2} , h = \frac{{h}_{e}}{4} and h = \frac{{h}_{e}}{8}$$

to illustrate the concept

$$\begin{matrix}[ \frac{{h}_{e}}{2} ( \frac{w}{c} - \frac{n π}{\frac{{h}_{e}}{2}} ) ] = [ {h}_{e} ( \frac{\frac{w}{2}}{c} - \frac{n π}{{h}_{e}} ) ] \\ [ \frac{{h}_{e}}{4} ( \frac{w}{c} - \frac{n π}{\frac{{h}_{e}}{4}} ) ] = [ {h}_{e} ( \frac{\frac{w}{4}}{c} - \frac{n π}{{h}_{e}} ) ] \\ [ \frac{{h}_{e}}{8} ( \frac{w}{c} - \frac{n π}{\frac{{h}_{e}}{8}} ) ] = [ {h}_{e} ( \frac{\frac{w}{8}}{c} - \frac{n π}{{h}_{e}} ) ] \\ ⋮\end{matrix} \qquad ( 25 )$$

The right hand side of the Eq. 25 indicates that a fraction of properties of the tested material with thickness of hₑ can plenarily be used to predict properties of the thinner material. We can compare the computed results from Eqs. 21, 22 and 24 in which both sides of the Eq. 25 and the

$$[ {h}_{e} ( \frac{ω}{c} - \frac{n π}{{h}_{e}} ) ]$$

were used as augments to these equations to illustrate the interchangeability between the frequency and the thickness. Likewise, for predicting thicker material, h=2hₑ, h=4hₑ and h=8hₑ, interchangeability obviously becomes

$$\begin{matrix}[ 2 {h}_{e} ( \frac{ω}{c} - \frac{n π}{2 {h}_{e}} ) ] & = & [ {h}_{e} ( \frac{2 ω}{c} - \frac{n π}{{h}_{e}} ) ] \\ [ 4 {h}_{e} ( \frac{ω}{c} - \frac{n π}{4 {h}_{e}} ) ] & = & [ {h}_{e} ( \frac{4 ω}{c} - \frac{n π}{{h}_{e}} ) ] \\ [ 8 {h}_{e} ( \frac{ω}{c} - \frac{n π}{8 {h}_{e}} ) ] & = & [ {h}_{e} ( \frac{8 ω}{c} - \frac{n π}{{h}_{e}} ) ] \\ & ⋮ & \end{matrix} \qquad ( 26 )$$

The right hand side of the Eq. 26 indicates that for predicting thicker material, the original material must be tested under wider frequency bandwidth than the thicker one. For example, an 1-inch material, if tested in the bandwidth of 0 to 10000 Hz, is capable of predicting a 2-inch of the same material in the bandwidth of 0 to 5000 Hz.

### DESCRIPTION OF THE DRAWINGS

1. FIG. 1: One Dimensional Acoustic two-microphone Impedance Tube.

2. FIG. 2: Measured one dimensional normal incident absorption curve in the range of 0 to 6.25 kHz. Flexible porous material sample #1 with thickness 2.54 cm.

3. FIG. 3: Predicted one dimensional normal incident absorption curve in the range of 0 to 6.25 kHz. Flexible porous material sample 1 with thickness 2.54 cm.

4. FIG. 4: Plot of Eq. 18 of flexible porous material in the range of 0 to 6.25 kHz. sample #1 with thickness 2.54 cm.

5. FIG. 5: Plot of Specific-Mass m(w, h) in the range of 0 to 6.25 kHz. Flexible porous material sample #1 with thickness 2.54 cm.

6. FIG. 6: Plot of Porosity p(w, h) in the range of 0 to 6.25 kHz. Flexible porous material sample #1 with thickness 2.54 cm.

7. FIG. 7: Plot of Flow-Resistance r(w, h) in the range of 0 to 6.25 kHz. Flexible porous material sample #1 with thickness 2.54 cm.

8. FIG. 8: Measured acoustic impedance in the range of 0 to 6.25 kHz. Flexible porous material sample #1 with thickness 2.54 cm.

9. FIG. 9: Plot of \sqrt{p(w, h)×p(w, h)} in the range of 0 to 6.25 kHz. Flexible porous material sample #1 with thickness 2.54 cm.

10. FIG. 10: Measured one dimensional normal incident absorption curve in the range of 0 to 6.25 kHz. Flexible porous material sample #2 with thickness 3.49 cm.

11. FIG. 11: Predicted one dimensional normal incident absorption curve in the range of 0 to 6.25 kHz. Flexible porous material sample 2 with thickness 3.49 cm.

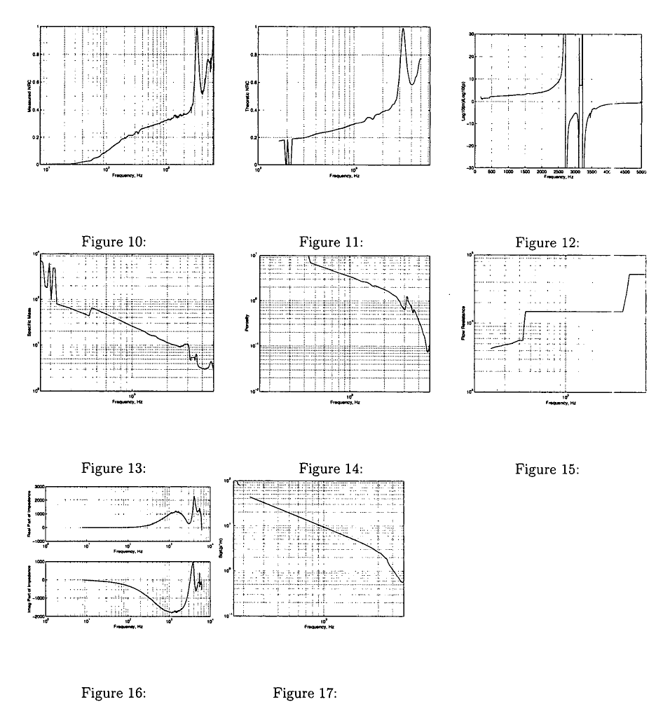

12. FIG. 12: Plot of Eq. 18 in the range of 0 to 6.25 kHz. Flexible porous material sample #2 with thickness 3.49 cm.

13. FIG. 13: Plot of Specific-Mass m(w, h) in the range of 0 to 6.25 kHz. Flexible porous material sample #2 with thickness 3.49 cm.

14. FIG. 14: Plot of Porosity p(w, h) in the range of 0 to 6.25 kHz. Flexible porous material sample #2 with thickness 3.49 cm.

15. FIG. 15: Plot of Flow-Resistance r(w, h) in the range of 0 to 6.25 kHz. Flexible porous material sample #2 with thickness 3.49 cm.

16. FIG. 16: Measured acoustic impedance in the range of 0 to 6.25 kHz. Flexible porous material sample #2 with thickness 3.49 cm.

17. FIG. 17: Plot of \sqrt{p(w, h)×p(w, h)} in the range of 0 to 6.25 kHz. Flexible porous material sample #2 with thickness 3.49 cm.

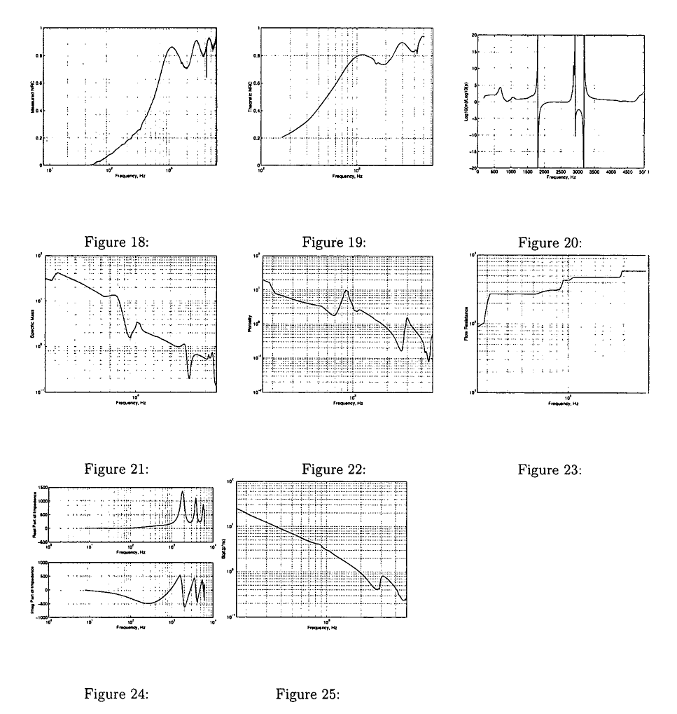

18. FIG. 18: Measured one dimensional normal incident absorption curve in the range of 0 to 6.25 kHz. Flexible porous material sample #3 with thickness 8.10 cm.

19. FIG. 19: Predicted one dimensional normal incident absorption curve in the range of 0 to 6.25 kHz. Flexible porous material sample 3 with thickness 8.10 cm.

20. FIG. 20: Plot of Eq. 18 in the range of 0 to 6.25 kHz. Flexible porous material sample #1 with thickness 8.10 cm.

21. FIG. 21: Plot of Specific-Mass m(w, h) in the range of 0 to 6.25 kHz. Flexible porous material sample #3 with thickness 8.10 cm.

22. FIG. 22: Plot of Porosity p(w, h) in the range of 0 to 6.25 kHz. Flexible porous material sample #3 with thickness 8.10 cm.

23. FIG. 23: Plot of Flow-Resistance r(w, h) in the range of 0 to 6.25 kHz. Flexible porous material sample #3 with thickness 8.10 cm.

24. FIG. 24: Measured acoustic impedance in the range of 0 to 6.25 kHz. Flexible porous material sample #3 with thickness 8.10 cm.

25. FIG. 25: Plot of \sqrt{p(w, h)×p(w, h)} in the range of 0 to 6.25 kHz. Flexible porous material sample #3 with thickness 8.10 cm.

26. FIG. 26: Measured one dimensional normal incident absorption curve in the range of 0 to 6.25 kHz. Flexible porous material sample #4 with thickness 3.65 cm.

27. FIG. 27: Predicted one dimensional normal incident absorption curve in the range of 0 to 6.25 kHz. Flexible porous material sample 4 with thickness 3.65 cm.

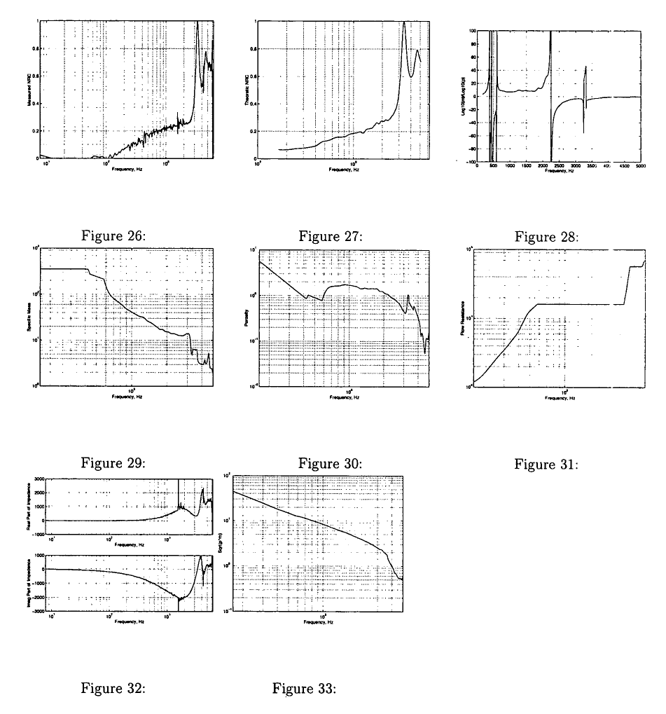

28. FIG. 28: Plot of Eq. 18 in the range of 0 to 6.25 kHz. Flexible porous material sample #4 with thickness 3.65 cm.

29. FIG. 29: Plot of Specific-Mass m(w, h) in the range of 0 to 6.25 kHz. Flexible porous material sample #4 with thickness 3.65 cm.

30. FIG. 30: Plot of Porosity p(w, h) in the range of 0 to 6.25 kHz. Flexible porous material sample #4 with thickness 3.65 cm.

31. FIG. 31: Plot of Flow-Resistance r(w, h) in the range of 0 to 6.25 kHz. Flexible porous material sample #4 with thickness 3.65 cm.

32. FIG. 32: Measured acoustic impedance in the range of 0 to 6.25 kHz. Flexible porous material sample #4 with thickness 3.65 cm.

33. FIG. 33: Plot of \sqrt{p(w, h)×p(w, h)} in the range of 0 to 6.25 kHz. Flexible porous material sample #4 with thickness 3.65 cm.

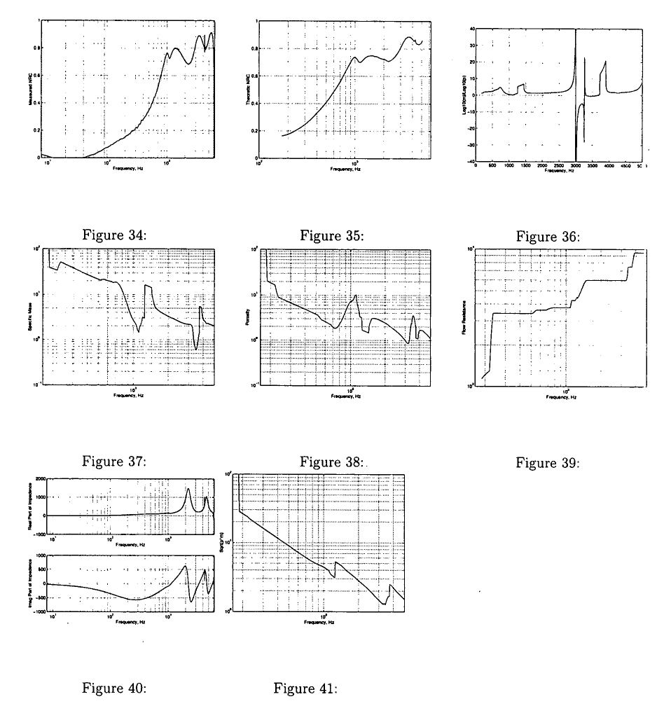

34. FIG. 34: Measured one dimensional normal incident absorption curve in the range of 0 to 6.25 kHz. Flexible porous material sample #5 with thickness 6.35 cm.

35. FIG. 35: Predicted one dimensional normal incident absorption curve in the range of 0 to 6.25 kHz. Flexible porous material sample 5 with thickness 6.35 cm.

36. FIG. 36: Plot of Eq. 18 in the range of 0 to 6.25 kHz. Flexible porous material sample #5 with thickness 6.35 cm.

37. FIG. 37: Plot of Specific-Mass m(w, h) in the range of 0 to 6.25 kHz. Flexible porous material sample #5 with thickness 6.35 cm.

38. FIG. 38: Plot of Porosity p(w, h) in the range of 0 to 6.25 kHz. Flexible porous material sample #5 with thickness 6.35 cm.

39. FIG. 39: Plot of Flow-Resistance r(w, h) in the range of 0 to 6.25 kHz. Flexible porous material sample #5 with thickness 6.35 cm.

40. FIG. 40: Measured acoustic impedance in the range of 0 to 6.25 kHz. Flexible porous material sample #5 with thickness 6.35 cm.

41. FIG. 41: Plot of \sqrt{p(w, h)×p(w, h)} in the range of 0 to 6.25 kHz. Flexible porous material sample #5 with thickness 6.35 cm.

What is claimed is:

1. Space-Mass Relationship
$$p ( ω , h ) = {m}^{H} ( ω , h )$$
$$or$$
$$\frac{log [ p ( w , h ) ]}{log [ m ( ω , h ) ]} = H$$
$$where$$
$$H = {\sum }_{n = 0}^{N} \{ {k}_{n 1} Ai [ h ( \frac{ω}{c} - \frac{n π}{h} ) ] + {k}_{n 2} Bi [ h ( \frac{ω}{c} - \frac{n π}{h} ) ] \}$$
This empirical equation describes the relationship between the porosity and the specific: added air mass inside pore of a material comprising:
a linear combination of the first kind of the Airy function, Ai[], and the second kind )f the Airy function, Bi[], in a form of summation, and
a dispersion relationship,
$$h ( \frac{ω}{c} - \frac{n π}{h} ) ,$$
which is an unique argument of the first kind of the Airy function, Ai[], and the second kind of the Airy function, Bi[], and
a set of coefficients, kₙ₁ and kₙ₂ for each pair of Airy functions, which are obtained by fitting Space-Mass Relationship to a specific material data and are uniquely used to identify this specific material and can be used for similarity analysis or further computation in accordance with empirical equation described in Space-Mass Relationship.

2. Space-Mass Identity
$${p}^{log [ m ( ω , h ) ]} ( ω , h ) = {m}^{log [ p ( ω , h ) ]} ( ω , h )$$
$$or$$
$$log [ p ( ω , h ) ] \times log [ m ( ω , h ) ] = J$$
$$where$$
$$J = {\sum }_{n = 0}^{N} \{ {k}_{n 3} Ai [ h ( \frac{ω}{c} - \frac{n π}{h} ) ] + {k}_{n 4} Bi [ h ( \frac{ω}{c} - \frac{n π}{h} ) ] \}$$
This empirical equation describes an identity between the porosity and the specific air mass inside pore of a material comprising:
a linear combination of the first kind of the Airy function, Ai[], and the second kind of the Airy function, Bi[], in a form of summation, and
a dispersion relationship,
$$h ( \frac{ω}{c} - \frac{n π}{h} ) ,$$
which is an unique argument of the first kind of the Airy function, Ai[], and the second kind of the Airy function, Bi[], and
a set of coefficients, kₙ₃ and kₙ₄ for each pair of Airy functions, which are obtained by fitting Space-Mass Identity to a specific material data and are uniquely used to identify this specific material and can be used for similarity analysis or further computation in accordance with empirical equation described in Space-Mass Identity.

3. Flow Resistance.
$$h \times r ( ω , h ) \times \sqrt{\frac{p ( ω , h )}{m ( ω , h )}} = K$$
$$where$$
$$K = {\sum }_{n = 0}^{N} \{ {k}_{n 5} Ai [ h ( \frac{ω}{c} - \frac{n π}{h} ) ] + {k}_{n 6} Bi [ h ( \frac{ω}{c} - \frac{n π}{h} ) ] \}$$
This empirical equation describes the flow resistance coupled by porosity and specific air mass inside pore of a material comprising:
a linear combination of the first kind of the Airy function, Ai[], and the second kind of the Airy function, Bi[], in a form of summation, and
a dispersion relationship,
$$h ( \frac{ω}{c} - \frac{n π}{h} ) ,$$
which is an unique argument of the first kind of the Airy function, Ai[], and the second kind of the Airy function, Bi[], and
a set of coefficients, kₙ₅ and kₙ₆ for each pair of Airy functions, which are obtained by fitting Space-Mass Relationship, Space-Mass Identity and Flow Resistance to a specific material data and are uniquely used to identify this specific material and can be used for similarity analysis or further computation in accordance with those empirical equations described in Space-Mass Relationship, Space-Mass Identity and Flow Resistance.

4. Prediction Using Frequency-Thickness Interchangeability
A Frequency-Thickness Interchangeability, described by
$$h ( \frac{ω}{c} - \frac{n π}{h} )$$
in accordance with those empirical equations described in Space-Mass Relationship, Space-Mass Identity and Flow Resistance, can be used to predict porosity, specific added air mass and flow resistance in any thickness.
